(19) United States
(12) Patent Application Publication
(10) Pub. No.: US 2025/0132819 A1
(43) Pub. Date: Apr. 24, 2025

(54) TERMINAL-TO-TERMINAL COMMUNICATION IN SATELLITE NETWORKS

(71) Applicant: Hughes Network Systems, LLC, Germantown, MD (US)

(72) Inventors: Channasandra S. Ravishankar, Clarksburg, MD (US); Deepak M. Arur, Vienna, VA (US); Ganeshan Ramachandran, Frederick, MD (US); Subramanya B. Krishna, Rockville, MD (US); Gaguk Zakaria, College Park, MD (US); Nassir BenAmmar, Rockville, MD (US)

(21) Appl. No.: 18/924,848

(22) Filed: Oct. 23, 2024

Related U.S. Application Data
(60) Provisional application No. 63/545,356, filed on Oct. 23, 2023.

(51) Int. Cl. H04B 7/185

(52) U.S. Cl. CPC H04B 7/18521

(57) ABSTRACT

Methods, systems, and apparatus, including computer programs encoded on computer-storage media, for terminal-to-terminal communication in satellite networks. In some implementations, a system includes an application server that enables a communication session that routes user data between a first terminal and a second terminal over a satellite communication network without routing the user data through any intermediate ground stations.

### CROSS-REFERENCE TO RELATED APPLICATIONS

This application claims the benefit of priority to U.S. Provisional Patent Application No. 63/545,356, filed on Oct. 23, 2023, the entire contents of which are incorporated by reference in their entirety.

### BACKGROUND

The present specification relates to techniques for enabling communication between satellite terminals in satellite communication networks.

Satellite communication networks provide important communication services in many areas. For example, a satellite communication network can serve as a radio access network for various types of communication, including voice calls, data transfer, Internet access, media streaming, and more.

### SUMMARY

In some implementations, a system provides techniques for establishing and using connections between terminals in a satellite network. For example, the system can be configured to establish and maintain terminal-to-terminal connections that route user data through satellites and do not route user data through ground-based stations and ground-based networks. The ability to create terminal-to-terminal connections can improve security by avoiding the possibility of ground-based interception, because there are no ground-based elements where data can be intercepted. In a terminal-to-terminal connection, user data can pass from the sending terminal to one or more satellites and then to the receiving terminal, thus avoiding the need for user data to pass through a terrestrial gateway, ground radio access network (GRAN), or other ground-based stations or networks.

The system can facilitate terminal-to-terminal connections through satellites using an application server that cooperates with core networks and ground-based networks to establish connections. For example, terminals can each exchange signals from a satellite providing connectivity in their area. The terminals can be in different cells or coverage areas that may be served by different satellites. The satellites are connected to ground radio access networks and terrestrial core networks, and the terminals attach to or become registered in these ground-based networks. An application server helps coordinate the creation of a new terminal-to-terminal connection through various messages provided through the core networks. Once appropriate routing paths have been established for two terminals to communicate through the satellites alone, the communication session can proceed with user data being sent between the terminals and satellites, without passing through any intermediate ground stations or ground-based networks. During the terminal-to-terminal session, the terminals maintain their attachment to the ground radio access network. As a result, when time for satellite handover occurs, the terminals can request for the ground-based routing determination function (RDF) to calculate a new routing path through the satellites, so the terminal-to-terminal connection can continue with an updated path through the satellites.

The system can provide terminal-to-terminal communication sessions using multiple satellites in a low earth orbit (LEO) or a medium earth orbit (MEO). A constellation of interlinked satellites can provide good coverage and relatively low latency. Nevertheless, satellites in LEO or MEO change their position over the user, and so the set of satellites in range above a terminal can change quickly, sometimes with individual satellites providing coverage for a few minutes at a time. The system can maintain the attachment of terminals to ground-based networks while terminal-to-terminal communications occur. The terminals can then use the continued attachment to the ground-based networks to determine new routings among the satellites whenever satellite handover occurs for either of the terminals in the communication session. In this case, the ground-based networks are used for establishing the terminal-to-terminal session and for periodically updating routing through the satellite constellation, but user data (e.g., voice data, video data, etc.) does not pass through the ground-based networks.

This arrangement can provide the advantages of terminal-to-terminal satellite communication, while also minimizing the complexity of the operation of the satellites. For example, even as the user data is passed only through satellites, the routing determinations can be performed by ground-based processing systems, which relieves the satellites from the need to consume power and processing resources to determine routing. The ground-based infrastructure can determine label stacks representing paths between satellites, where each label stack indicates a series of satellites through packets are passed to send from a source satellite to a destination satellite or from a source cell to a destination cell. For example, a resource manager (e.g., a Global Resource Manager (GRM)) can track which satellites serve the various cells. The satellites can also obtain label stacks to reach other satellites in the constellation through the satellite constellation (e.g., directly or through one or more intermediate satellites). When satellite handover occurs, the satellites involved in a terminal-to-terminal connection can be provided new label stacks to continue the communication session.

When terminals send data for transmission in a terminal-to-terminal session, the terminals can include values in the headers of the packets that facilitate the routing of the packets to the destination, e.g., the destination satellite, destination cell, and ultimately the destination terminal. First, the packet headers can include an indicator that the packet is part of a terminal-to-terminal session, and thus that it should be routed solely through a satellite constellation, and not through any ground-based networks. The indicator can be a flag or value that specifies that the packet is part of a terminal-to-terminal session. For example, a particular field (e.g., one or more bits) can be designated for indicating whether the packet is part of a terminal-to-terminal session (e.g., “1” indicates a terminal-to-terminal session, “0” indicates a standard session involving the ground-based radio access network and/or core network). As another example, rather than a specific dedicated field, a particular value (or a predetermined value in a predetermined set or range of values) can indicate that it is a terminal-to-terminal session, even if the value (e.g., a code, marker, signal, etc.) is part of another field that may be used for multiple purposes. In addition, or as an alternative, the packet headers can be generated to include information such as a cell identifier for a destination cell in which the destination terminal is located, a temporary identifier for the destination terminal in the destination cell, and a logical channel identifier (e.g., to specify that the data represents user data). In some implementations, the presence of the destination information (e.g., cell identifier for the destination cell and the temporary identifier for the destination terminal in the destination cell, or both) can, together with another flag or field value, serve as an indicator that the packet is part of a terminal-to-terminal session.

In one general aspect, a method performed by one or more computers includes: enabling, by the one or more computers, a communication session that routes user data between a first terminal and a second terminal over a satellite communication network without routing the user data through any intermediate ground stations, comprising: receiving, by the one or more computers, a discovery message from a first terminal for initiating communication with a second terminal, wherein the first terminal is located in a first cell and communicates with a first satellite, and wherein the discovery message includes an identifier for the second terminal; in response to receiving the discovery message, sending, by the one or more computers, a query directed to the second terminal using a network address for the second terminal; receiving, by the one or more computers, a response to the query from the second terminal, wherein the response includes a cell identifier for a second cell where the second terminal is located, a satellite identifier for a second satellite with which the second terminal communicates, and a temporary identifier of the second terminal; and after receiving the response to the query, sending, by the one or more computers, a discovery response to the first terminal, wherein the discovery response includes the cell identifier for the second cell and the temporary identifier for the second terminal.

In some implementations, the method includes notifying a resource manager associated with one or more ground-based radio access networks that the first terminal and the second terminal are establishing a terminal-to-terminal communication session, such that the resource manager responds to routing requests for the first terminal and the second terminal to provide label stacks for a satellite-to-satellite path of communication between the first satellite and second satellite.

In some implementations, the network address of the second terminal is an Internet protocol (IP) address, and wherein the query provides an Internet protocol (IP) address for the first terminal to the second terminal.

In some implementations, the discovery message comprises a proximity services identifier for the second terminal; and the method comprises determining a network address for the second terminal based on the proximity services identifier for the second terminal.

In some implementations, the method includes providing, to the first terminal and the second terminal, security parameters for the communication session.

In some implementations, providing the security parameters comprises providing one or more encryption keys for encryption of user data passed between the first terminal and the second terminal in the communication session, wherein the one or more encryption keys are different from encryption keys used by the first terminal and second terminal for communication with ground radio access networks.

In some implementations, sending the query comprises sending a presence query message.

In some implementations, the method includes, before enabling the communication session: registering the first terminal; providing, to a route determining function (RDF), an update comprising information about the first terminal; registering the second terminal; and providing, to a route determining function (RDF), an update comprising information about the second terminal.

In some implementations, the first cell is different from the second cell, and the first satellite is different from the second satellite.

In some implementations, the identifier for the second terminal comprises a proximity services (ProSe) identifier for the second terminal.

In some implementations, the temporary identifier for the second terminal comprises a Serving Temporary Mobile Subscriber Identity (S-TMSI) for the second terminal.

In some implementations, sending the query directed to the second terminal comprises sending the query to the second terminal through a ground radio access network associated with the second terminal.

In some implementations, the one or more computers are one or more computers of an application server.

In some implementations, the one or more computers provide application server functionality that enables terminals to discover other terminals that are connected through different radio access networks or different core networks to discover each other and establish terminal-to-terminal connections through a satellite constellation, including by: registering terminals and storing for each of the registered terminals at least one of a network address, a cell identifier, a satellite identifier, a proximity services identifier, a device identifier, or a temporary identifier; and facilitate terminal-to-terminal connections through a satellite constellation by exchanging, among a pair of terminals, information of the terminals in the pair that was obtained through the registration processes of the terminals in the pair.

In some implementations, enabling the communication session comprises providing a notification of a terminal-to-terminal session to a core network or radio access network, wherein the notification identifies the first terminal and the second terminal.

In some implementations, the notification indicates that a terminal-to-terminal session exists, is being established, or should be established.

In another general aspect, a method includes: sending, by a first terminal, a discovery message to an application server configured to enable device-to-device communication sessions, wherein the first terminal is in a first cell and is connected to a network through a first satellite, wherein the discovery message includes an identifier for a second terminal; receiving, by the first terminal, a discovery response from the application server, wherein the second terminal is in a second cell and is connected to the network through a second satellite, wherein the discovery response includes (i) a cell identifier for the second cell and (ii) a temporary identifier for the second terminal; sending, by the first terminal, a request message to a ground radio access network to initiate a route label request, wherein the request message includes the cell identifier for the second cell and at least a portion of the temporary identifier for the second terminal; after sending the request message, communicating, by the first terminal, with the second terminal in a communication session that routes user data through the first satellite and the second satellite without routing the user data through intermediate ground stations.

In some implementations, the method includes receiving, from the application server, security parameters for the communication session.

In some implementations, the security parameters comprise one or more encryption keys for encryption of data passed between the first terminal and the second terminal in the communication session, wherein the one or more encryption keys are different from encryption keys used for communication with ground radio access networks; and the method comprises sending data to or receiving data from the second terminal in the communication session, wherein the data is encrypted using the one or more encryption keys.

In some implementations, the temporary identifier comprises a Serving Temporary Mobile Subscriber Identity (S-TMSI).

In some implementations, the request message comprises a radio resource control (RRC) message to cause a route determining function associated with a core network to determine route labels.

In some implementations, the method includes: obtaining a network address for the second terminal from the discovery response; and communicating with the second terminal by sending packets that indicate the network address of the second terminal from the discovery response as a destination network address for the packets.

In some implementations, the method includes communicating with the second terminal by sending packets that have headers that comprise one or more values indicating that the packets are part of a terminal-to-terminal session.

In some implementations, the headers comprise Packet Data Convergence Protocol (PDCP) Extension headers.

In some implementations, the method includes communicating with the second terminal by exchanging packets over a network tunnel established between the first satellite and the second satellite.

In some implementations, the network tunnel is a general packet radio service (GPRS) Tunneling Protocol (GTP) tunnel.

In some implementations, the method includes communicating with the second terminal by sending packets that have headers that comprise a cell identifier for the second cell, a
cell ID, Cell Radio Network Temporary Identifier (CRNTI) of the second terminal, and a Logical Channel Identifier (LCID).

In some implementations, the first cell is different from the second cell, and the first satellite is different from the second satellite.

In some implementations, the method includes detecting, by the first terminal, an upcoming handover that will cause the first terminal to communicate with a different satellite instead of the first satellite; and before the upcoming handover occurs, sending, by the first terminal, a notification message informing the second terminal of the upcoming handover.

In some implementations, the notification message is sent as a control plane application message over a terminal-to-terminal link of the communication session that routes the notification message through satellites but does not route the notification message through intermediate ground stations.

In some implementations, the first terminal is attached to a ground radio access network, and wherein attachment of the first terminal with the ground based-radio network is maintained during the communication session.

In some implementations, the method includes, before sending the discovery message to the application server, registering with the application server using messaging that occurs through the ground radio access network through which the first terminal is attached.

In some implementations, registering with the application server comprises providing at least one of a network address assigned to the first terminal by the ground radio access network, a cell identifier for a cell where the first terminal is located, a satellite identifier for a satellite providing connectivity for the cell where the first terminal is located, a proximity services identifier for the first terminal, a device identifier for the first terminal, or a temporary identifier for the first terminal.

In some implementations, the method includes maintaining attachment to the ground radio access network during a terminal-to-terminal communication session with the second terminal that routes user data through a satellite constellation without routing data through any ground radio access networks.

In some implementations, the method includes, during the terminal-to-terminal communication session, communicating at least some control information or connection management information over a connection path that includes the ground radio access network.

In some implementations, the method includes communicating with the ground radio access network or a ground-based core network to cause a ground-based route determining function to update a routing path through the satellite constellation for the terminal-to-terminal communication session with the second terminal.

In some implementations, the terminal-to-terminal communication session is established such that the ground-based route determining function updates the routing path through the satellite constellation for the terminal-to-terminal communication session to account for at least one of satellite handover for the first terminal, satellite handover for the second terminal, a change in cell of the first terminal, or a change in cell of the second terminal.

In some implementations, the method includes: receiving, by the first terminal, a notification message indicating an upcoming satellite handover for the second terminal; and in response to receiving the sending, by the first terminal, a radio resource control (RRC) message to a ground radio access network to request an update to routing labels to reach the new satellite.

In some implementations, the identifier for the second terminal is a proximity services (ProSe) identifier.

In some implementations, the first terminal is a very small aperture terminal (VSAT) and wherein the second terminal is a VSAT.

In some implementations, the first terminal or the application server provides a cell identifier for a cell where the second terminal is located to a ground radio access network or core network to cause a ground-based system to (i) generate a set of labels that specify a communication path from the first satellite to the second satellite through a satellite constellation without passing through any ground radio access networks and (2) transmit the generated set of labels to the first satellite.

In some implementations, the method includes receiving routing information for at least a portion of a network path to communicate with the second terminal.

In some implementations, the routing information comprises a cell identifier for a cell where the second terminal is located.

In some implementations, the method includes using the received cell identifier for the cell where the second terminal is located to send messages directed to the second terminal, and wherein the first satellite provides the messages to the second satellite using a set of labels, generated by a ground-based system and passed to the first satellite, that specify a communication from the first satellite to the second satellite, which serves the cell where the second terminal is located, through a satellite constellation without passing through any ground radio access networks.

In another general aspect, a method of enabling a communication session between a first terminal located in a first cell that is served by a first satellite and a second terminal located in a second cell that is served by a second satellite, the method comprising: receiving, by the second terminal, a query from an application server; sending, by the second terminal, a response to the query to the application server, wherein the response includes a cell identifier for the second cell where the second terminal is located, a satellite identifier for the second satellite with which the second terminal communicates, and a temporary identifier of the second terminal; and after sending the response message, communicating, by the second terminal, with the first terminal in a communication session that routes user data through the second satellite and the first satellite without routing the user data through intermediate ground stations.

In some implementations, the method includes sending, by the first terminal, a request message to a ground radio access network to initiate a route label request, to trigger the generation of a set of routing labels that specify a connection path through a satellite constellation from the second satellite to the first satellite without passing through any ground radio access networks.

In some implementations, the method includes: receiving (i) a cell identifier for the first cell where the first terminal is located or (ii) a satellite identifier for the first satellite that serves the first cell; and using the received cell identifier or the received satellite identifier to direct messages to the first terminal in the communication session.

In some implementations, the method includes receiving a network address of the first terminal; and using the received network address of the first terminal to direct messages to the first terminal in the communication session.

In another general aspect, a method includes: receiving, by a first satellite, a set of routing labels that specify a communication path for transmitting data to a second satellite in a satellite constellation without passing the data through any ground radio access network; receiving, by a first satellite, a packet from a first terminal over a wireless connection with the first terminal, wherein the packet has a header that identifies a second terminal as a destination for the packet; detecting, by the first satellite, an indicator in the header of the packet, wherein the indicator indicates that the packet is part of a terminal-to-terminal communication session; and based on detecting the indicator, using, by the first satellite, the stored set of packet labels to route the packet to the second satellite over the communication path through the satellite constellation that does not pass the data through any ground radio access network.

In some implementations, the method includes selecting whether to route transmission of the packet through a path that includes or does not include a ground radio access network or ground-based core network based on whether the indicator is detected.

In some implementations, the method includes comprising selecting communication paths for transmitting packets based on whether the indicator is present in headers of the packets, including (i) selecting to route a first packet through the satellite constellation to a destination satellite using a stored routing label stack that does not pass through any ground radio access networks when the indicator is detected in the header of the packet, and (ii) selecting to route a second packet through a path that does include a ground radio access network when the indicator is not detected in the header of the packet.

In some implementations, the header of the packet includes at least one of a cell identifier for a destination cell in which the second terminal is located, a temporary identifier for the second terminal in the destination cell, or a logical channel identifier.

In some implementations, the indicator comprises the presence of the cell identifier for the destination cell, the temporary identifier for the second terminal in the destination cell, or both.

In some implementations, the indicator comprises a flag or value that is separate from the cell identifier, the temporary identifier, and the logical channel identifier.

In some implementations, the indicator comprises a predetermined value in a field designated for specifying whether the packet is part of a terminal-to-terminal communication session over a satellite constellation.

In some implementations, the indicator comprises a bit value located at a predetermined location or portion of the header that has been designated to indicate whether the packet is part of a terminal-to-terminal communication session over a satellite constellation.

In some implementations, receiving the set of routing labels comprises receiving the set of routing labels from a core network or ground radio access network.

In some implementations, receiving the set of routing labels comprises receiving the set of routing labels as part of establishing a terminal-to-terminal communication session between the first terminal and the second terminal that passes user data between the first terminal and the second terminal through the satellite constellation without passing through intermediate ground stations.

In another general aspect, a method includes: receiving, by a first satellite, a packet transmitted by another satellite, wherein the packet comprises data sent to a first terminal by a second terminal; detecting, by the first satellite, an indicator in a header of the packet, wherein the indicator indicates that the packet is part of a terminal-to-terminal communication session; based on detecting the indicator, selecting, by the first satellite, a destination cell from among multiple cells served by the first satellite, wherein the destination cell is selected based on a cell identifier in the header; and transmitting, by the first satellite, the packet to the destination cell.

In some implementations, the method includes selecting, from among multiple cell queues each storing data to transmit to a different cell served by the first satellite, a cell queue for transmitting the data to the destination cell.

In some implementations, the method includes placing Radio Link Control (RLC) blocks in the selected cell queue; and populating a media access control (MAC) header with a logical control identifier (LCID) in a downlink user link of the first terminal.

In some implementations, a system includes: an application server configured to register terminals attached to any of multiple core networks and exchange information among the terminals to establish terminal-to-terminal communication sessions through a satellite constellation; and a ground-based system comprising a route determining function associated with one or more ground radio access networks, wherein the route determining function is configured to generate routing label stacks between pairs of satellites through the satellite constellation and to provide the routing label stacks to the satellites to establish terminal-to-terminal communication sessions.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system, including satellites and ground-based networks.

FIG. 2 is a diagram that shows an example of signaling in the system.

FIG. 3 is a diagram that shows an example of establishing sessions with core networks in the system.

FIG. 4 is a diagram that shows an example of registration with an application server.

FIG. 5 is a diagram that shows an example of the application server providing an update to ground network functions, such as a Global Resource Manager (GRM) or Route Determining Function (RDF).

FIG. 6 is a diagram that shows examples of interactions for determining routing labels and establishing a terminal-to-terminal data path.

FIG. 7 is a diagram that shows an example of a terminal-to-terminal data path that has been established.

FIG. 8 is a diagram that shows an example of a protocol stack for supporting terminal-to-terminal data paths.

FIG. 9 is a diagram that shows an example of providing lawful intercept capability together with a terminal-to-terminal data path.

Like reference numbers and designations in the various drawings indicate like elements.

### DETAILED DESCRIPTION

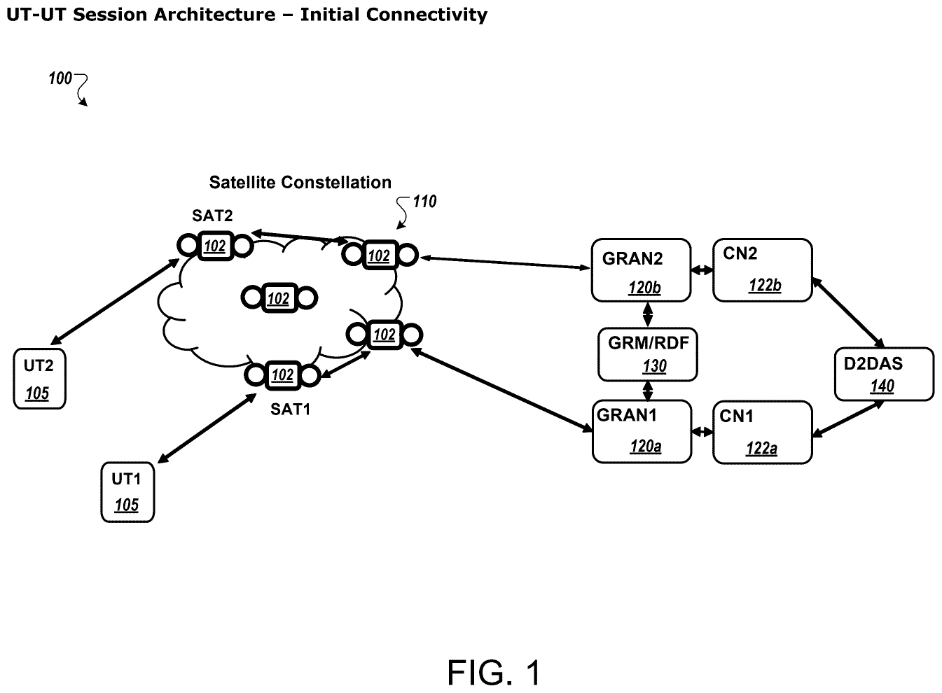

FIG. 1 is a diagram showing an example of a system 100 that includes satellites and ground-based networks. The system 100 includes a satellite constellation 110, that includes several satellites 102, including satellites labeled SAT1 and SAT2. The system 100 also includes various ground-based elements, including a first ground radio access network (GRAN1) 120a, a first core network (CN1) 122a, a second ground radio access network (GRAN2) 120b, a second core network CN2 (122b), a Global Resource Manager and Route Determining Function (GRM/RDF) 130, and an application server 140 (e.g., a device-to-device application server (D2DAS)). The system 100 also includes terminals 105, and two terminals 105 labeled UT1 and UT2 are illustrated. The terminals 105 can each be satellite terminals, such as very small aperture terminals (VSATs).

In the example, the two terminals UT1, UT2 each obtain network connectivity by exchanging wireless signals with satellites 102 in the satellite constellation 110. In the example, the first terminal UT1 is in a cell that is served by satellite SAT1, and the second terminal UT2 is in a cell that is served by satellite SAT2. Over time, the assignment of satellites 102 to cells will change, and so the terminals UT1, UT2 will communicate with different satellites 102 in the constellation 110 as discussed further below. The connectivity provided by the satellites 102 enables communication with the ground-based elements, such as the ground radio access networks 120a-120b, the core networks 122a-122b, and so on.

The satellite constellation 110 can include various satellites 102, including satellites orbiting in LEO and/or MEO. For example, the satellite constellation 110 can include dozens, hundreds, or thousands of satellites. Each of the satellites 102 can provide communication services to terminals 105 in various geographic areas, e.g., cells or coverage areas. Because the satellites 102 change position with respect to the ground during their orbit, the cells that a given satellite 102 services varies over time. The satellites 102 in the satellite constellation 110 are interlinked to communicate with each other, including to forward packets and provide other messages among themselves. For example, the satellites 102 may communicate with each other through optical links (e.g., laser communication links) or radiofrequency communication links.

The satellites 102 are configured to use routing information, such as a series of labels, to route packets through the satellite constellation 110. For example, the various satellites 102 can receive and store label stacks that each indicate a path to a different one of the other satellites 102. In some implementations, a label stack can be included in or applied to a packet (e.g., in a header) to indicate the path segments (e.g., steps or hops) from one satellite 102 to the next 102 from a source satellite 102 to a destination satellite 102. The satellites in the constellation 110 use the series of labels to pass a packet along each satellite 102 identified in the series, in sequence, until the packet reaches the destination satellite 102.

In the examples of FIGS. 1-9, an example with two terminals 105 is shown for clarity. In actual systems there can be many more terminals 105, many more satellites 102, additional ground radio access networks 120, additional core networks 122, and so on. In addition, the examples of FIGS. 1-9 show each of the terminals UT1, UT2 being located in different cells and exchanging wireless signals with different satellites 102, connecting to different ground radio access networks 120 and core networks 122, and so on. Nevertheless, the same techniques and principles apply when multiple terminals 105 are in the same cell, or exchange signals with the same satellite 102, or communicate through a single ground radio access network 120 and core network 122, and so on.

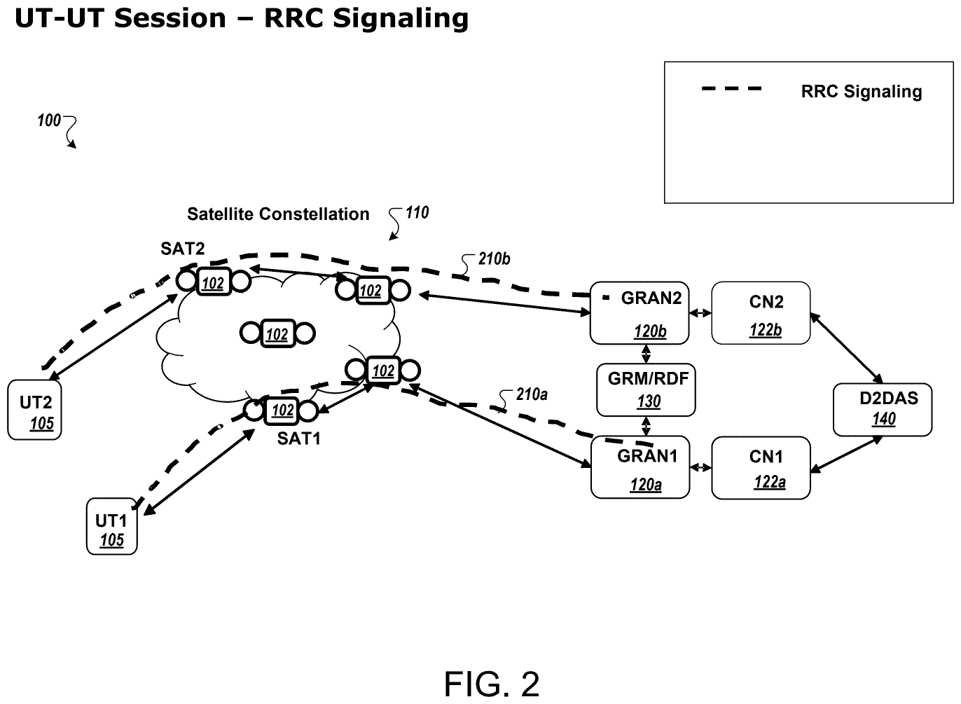

FIG. 2 is a diagram that shows an example of signaling in the system 100. In the example, each of the terminals 105 establishes a network connection through one of the satellites 102 that is serving the cell where the terminal 105 is located. The terminals 105 then attach to a ground radio access network 120a, 120b through the satellite constellation 110. This process includes radio resource control (RRC) signaling, which can be performed according to a Universal Mobile Telecommunications System (UMTS), Long-Term Evolution (LTE), 5G or similar protocol.

For example, a first RRC signaling path 210a is shown from the terminal UT1 to the satellite SAT1 through the satellite constellation 110 to the first ground radio access network GRAN1 120a. Similarly, a second RRC signaling path 210b is shown from the terminal UT2 to the satellite SAT2 through the satellite constellation 110 to the second ground radio access network GRAN2 120b.

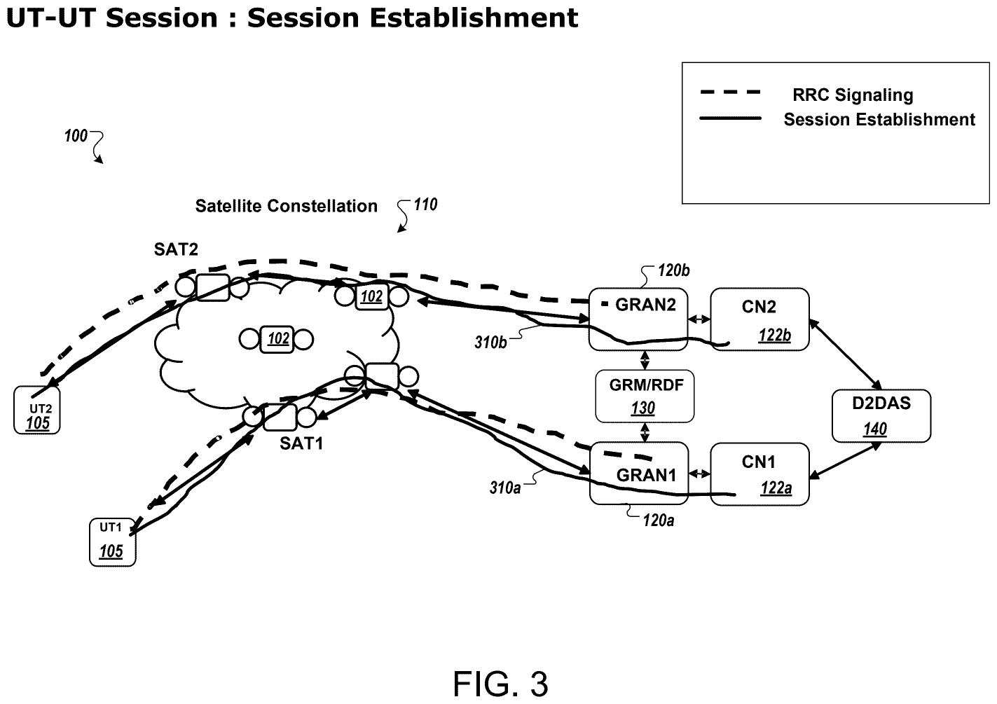

FIG. 3 is a diagram that shows an example of establishing sessions with core networks 120a, 120b in the system 100. After attaching using the RRC signaling as shown in FIG. 2, the terminals 105 establish sessions with a core network 120. In the illustrated example, the path 310a shows the path of communication for the terminal UT1 to establish a session with the core network 120a, and the path 310b shows the path of communication for the terminal UT2 to establish a session with the core network 120b. Establishing the sessions can involve the issuance of a network address, e.g., an Internet Protocol (IP) address for each of the terminals 105 in the network.

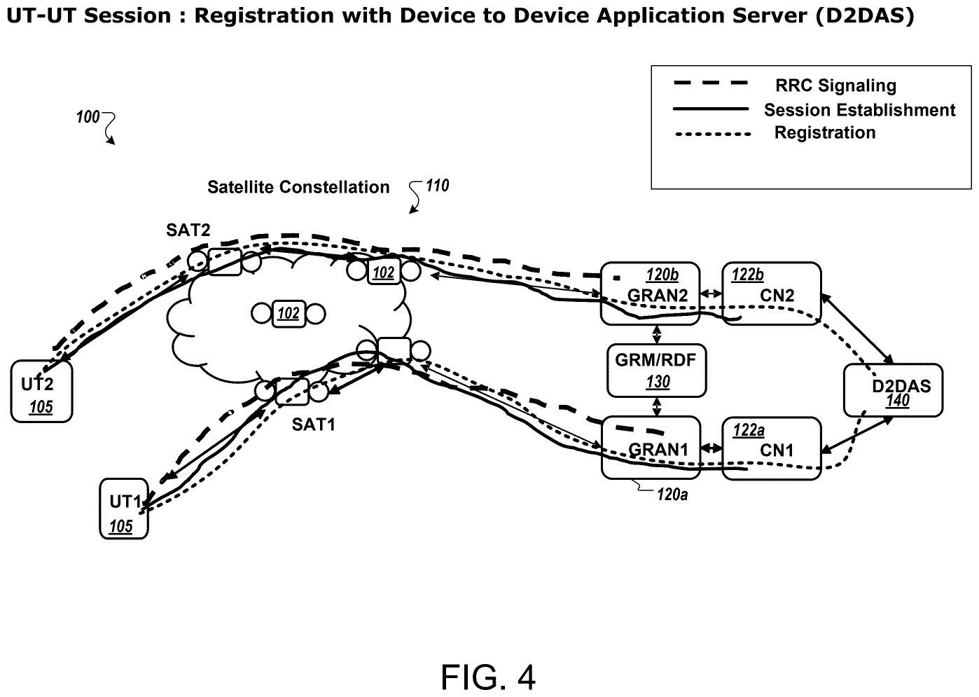

FIG. 4 is a diagram that shows an example of registration with the application server 140. The application server 140 can be provided as an element to facilitate the establishment of terminal-to-terminal connections through the satellite constellation, including for terminals 105 initially connected through different ground radio access networks 120a, 120b and/or core networks 122a, 122b. After each terminal 105 has a connection in a core network 122, the terminal 105 registers with the application server 140. Registration of a terminal 105 with the application server 140 can include storing a table that associates terminal identifiers with their current cell and IP address, along with potentially other information about the terminal 105. The application server 140 can be configured to track the locations, e.g., cells, that the various terminals 105 are in, and inform the Global Resource Manager/Route Determining Function (GRM/RDF) 130 so that routing can be performed effectively.

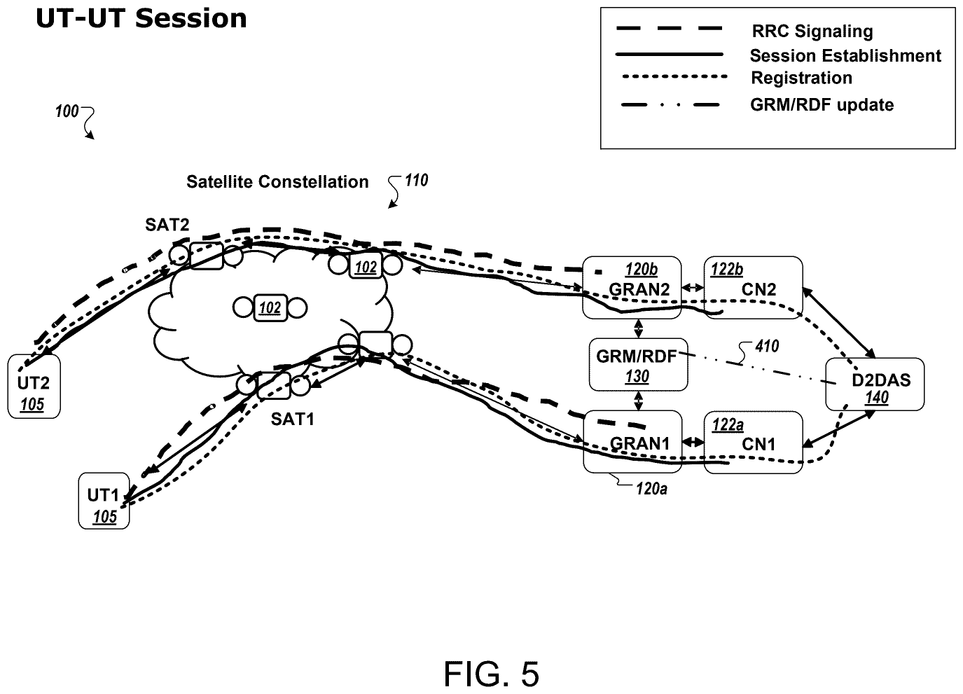

FIG. 5 is a diagram that shows an example of the application server 140 providing an update to ground network functions, such as the Global Resource Manager/Route Determining Function (GRM/RDF) 130. Once the terminals 105 have registered with the application server 140, the application server 140 informs the GRM/RDF 130, so that packets can be routed to each terminal 105 in its current cell. Over time, if the terminals 105 move from one cell to another, the terminals 105 notify the application server 140, and the application server 104 updates the location with the GRM/RDF 130.

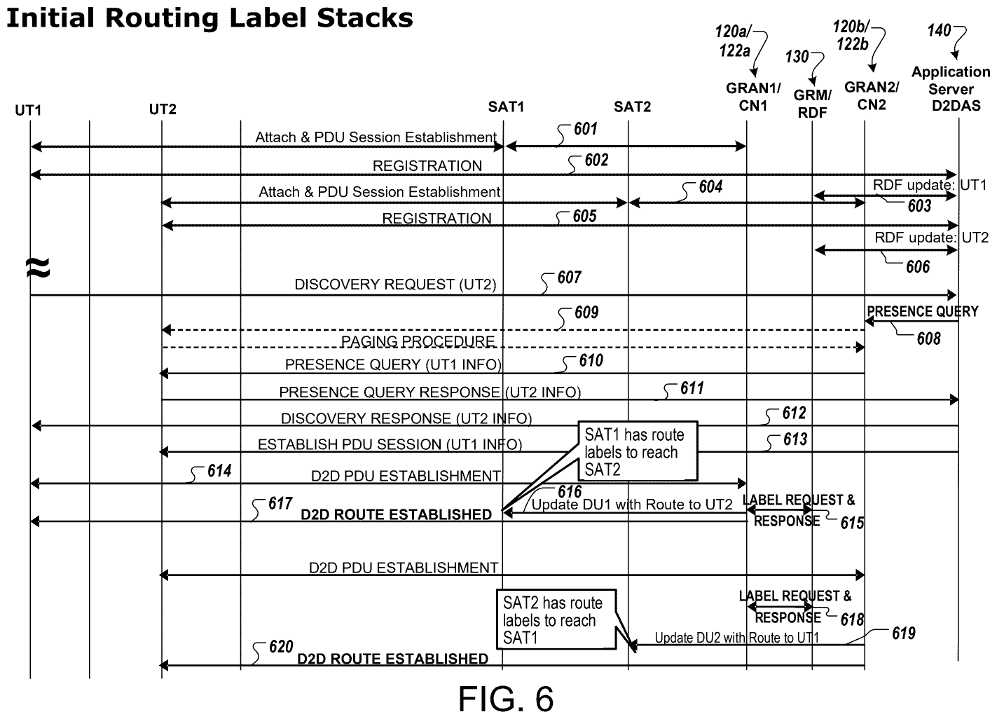

At the point shown in FIG. 5, the two terminals UT1 and UT2 are each attached to a ground radio access network 120a, 120b, are connected in a core network 122a, 122b, and have IP addresses assigned. If the user of terminal UT1 desires to establish a terminal-to-terminal connection, the application server 140 can facilitate the connection, including identifying a current location or cell identifier to use for routing information to the terminal UT2. The first terminal UT1 can send a message to the application server 140 identifying the second terminal UT2 with which to establish a connection. The application server 140 then sends a presence query message to the second terminal UT2 using the IP address for the terminal UT2. The terminal UT2 responds with various information about the location of the terminal (e.g., a cell identifier for its current cell and a satellite identifier for its current satellite, SAT2), as well as its identity in the core network. The application server 140 then performs messaging to coordinate among the terminals UT1, UT2 so that each has the IP address or other information needed to contact each other. The application server 140 can also communicate with the GRM/RDF 130 to indicate that a terminal-to-terminal session is being initiated, so the GRM/RDF 130 can appropriately set the label stacks for routing between the terminals UT1, UT2 through the satellite constellation 110 only, instead of through the ground radio access networks 120a, 120b and the core networks 122a, 122b. The interactions for initiating a terminal-to-terminal session are described further with respect to FIG. 6.

FIG. 6 is a diagram that shows examples of interactions for determining routing labels and establishing a terminal-to-terminal data path through the constellation 110.

As discussed above, the first terminal UT1 attaches to the ground radio access network 120a and establishes a session with the core network 120a to receive an IP address (601). This occurs by communication through the satellite SAT1 and potentially other satellites 102 to carry messages between the first terminal UT1 and the ground radio access network 120a. The first terminal UT1 also performs registration with the application server 140 (602). This registration can include, for example, the terminal UT1 providing its IP address, as well as other information, such as a cell identifier for the cell the terminal UT1 is in, a satellite identifier for the satellite SAT1 the terminal communicates with, a temporary identity for the terminal UT1 in the ground radio access network 120a and core network 122a, and so on. The application server 140 can also determine and store other information about the terminal UT1 and its network connection, such as which core network 122a or radio access network 120a the terminal UT1 connects through. The application server 140 then uses information from the registration of the terminal UT1 to update the route determining function 130 with information about the terminal UT1 (603).

The same types of steps are performed to bring the second terminal UT2 into connectivity. For example, the second terminal UT2 attaches to the ground radio access network 120b and establishes a session with the core network 120b to receive an IP address (604). The second terminal UT2 also performs registration with the application server 140 (605). The application server 140 then uses information from the registration of the terminal UT2 to update the route determining function 130 with information about the terminal UT2 (606).

Some time later, the user of the terminal UT1 decides to establish a direct terminal-to-terminal communication session with the terminal UT2, e.g., a communication session that carries user data directly through the satellite constellation 110 between the terminals UT1, UT2, without routing the user data through intermediate ground stations. The first terminal UT1 begins initiating this session by sending a user terminal discovery message to the application server 140 (607). The discovery message includes an identifier for the second terminal UT2, such as a proximity services (ProSe) identifier for the second terminal UT2. In response to the discovery message, the application server 140 then sends a presence query message to the second terminal UT2 using the IP address of the second terminal UT2 (608). For example, the application server 140 use the received ProSe identifier for the second terminal UT2 to look up the IP address for the terminal UT2 in the registration records stored by the application server 140.

If the second terminal UT2 is powered on and active when the presence query message is sent, then the terminal UT2 receives the message. However, if the second terminal is idle at the time, the core network 122a will initiate a paging procedure (609) to wake up the terminal UT2 so it can receive the presence query message. After paging, the second terminal UT2 receives the presence query message (610). The presence query message can include information about the first terminal UT1, such as an IP address for the first terminal UT1. The second terminal UT2 then generates and sends a presence query response (611) that includes its current cell identifier, satellite identifier, and temporary identifier (e.g., Serving Temporary Mobile Subscriber Identity S-TMSI).

With the presence query response from the second terminal UT2, the application server 140 sends a discovery response to the first terminal UT1 (612). The discovery response includes the cell identifier of the second terminal UT2 and the temporary identity (e.g., S-TMSI) of the second terminal UT2. With this information, the first terminal UT1 has the information it needs to initiate a terminal-to-terminal communication session with the second terminal UT2. The terminal UT1 sends an RRC message to its ground radio access network 120a to initiate a route label request towards the route determining function 130 (614). The RRC message can provide the cell identifier of the cell where the second terminal UT2 is located, as well as the temporary identifier (e.g., S-TMSI) information for the second terminal UT2. The application server 140 can also send information about the first terminal UT1 to the second terminal UT2 (613), such as a cell identifier for the cell where the first terminal UT1 is located and a temporary identifier (e.g., S-TMSI) for the first terminal UT1.

In response to the message from the first terminal UT1 that initiates the session, the corresponding core network 122a and ground radio access network 120a send a route label request to the route determining function 130. For example, an anchor router of the ground radio access network 120a sends a request to the global resource manager for a set pf route labels or a label stack to connect the first terminal UT1 in it's particular cell (Cell1) to communicate with the second terminal UT2 in its cell (Cell2). The global resource manager is aware of which satellites are serving Cell1 and Cell2. In some cases, the global resource manager may use special routes between two user terminals, e.g., different routes than might otherwise be used between other devices in the network or for other types of sessions. The route determining function 130 provides a set of labels to reach from the satellite SAT1 (serving Cell1 where the first terminal UT1 is located) to the satellite SAT2 (where the second terminal UT2 is located). The route determined, e.g., the sequence of labels each representing different satellites 102 in the constellation 110, can be based on physical-layer quality indicator (PQI) values specific to proximity services user terminal to user terminal communication. For example, when assessing the option for routing and determining a label stack, the route determining function 130 may apply thresholds or criteria for signal quality that are different for terminal-to-terminal communication than with other types of communication sessions.

After the label stack indicating the routing path from satellite SAT1 to satellite SAT2 through the constellation 110 is determined, the ground radio access network 120a sends the label stack to the satellite SAT1 (616). For example, the anchor router of the ground radio access network 120a can provide an update for the distributed unit (DU1) of the satellite SAT1. As a result, the satellite SAT1 has the label stack that it can apply to packets to route them through the constellation 110 to the satellite SAT2 without passing through any ground-based stations or networks. As a result, the terminal-to-terminal route from the first terminal UT1 to the second terminal UT2 through the satellite constellation 110 is established (617).

Complementary steps are performed to update routing information for the satellite SAT2. For example, the ground radio access network 120a (or potentially the ground radio access network 120b) makes a routing label request for a label stack for the reverse direction, from the satellite SAT2 to the satellite SAT1 through the satellite constellation 110 (618). The ground radio access network 120a (or potentially the ground radio access network 120b) can then cause the label stack for routing from satellite SAT2 to the satellite SAT1 to be provided to the satellite SAT2 (619), so the satellite SAT2 has the route labels to reach the satellite SAT1. Because both ground radio access networks 120a, 120b communicate with the RDF 130, one option is for the first ground radio access network 120a to initiate the route determination, and then for the route determining function 130 or other network components to provide the label stack to the core network 122b and ground radio access network 120b to be provided to the satellite SAT2. As another option, the label stack may be passed to the satellite SAT2 through the satellite constellation 110. With the satellite SAT2 having the label stack or series of labels to reach SAT1, the terminal-to-terminal route from the second terminal UT2 to the second terminal UT1 through the satellite constellation 110 is established (620). At this point, the satellite SAT1 and the satellite SAT2 both have label stacks to reach each other.

In some implementations, the creation and transfer of the labels stacks can be performed efficiently by introducing an application function in the global resource manager (GRM) of the GRM/RDF 130. For example, the application server 140 notifies the GRM of the two user terminals UT1, UT2 that are beginning the terminal-to-terminal session. This indication from the application server 140 signals to the GRM/RDF 130 that the routes determined between the two terminals UT1, UT2 should be made through the satellite constellation 110 only, without passing through any ground-based radio access networks or ground-based stations. When the individual ground radio access networks 120a, 120b associated with the two terminals UT1, UT2 send requests GRM/RDF 130 for label stacks for routing, the GRM/RDF 130 provides label stacks between satellites 102 only (e.g., instead of the routing label stacks to reach between a distributed unit (DU) and central unit (CU) of ground networks) because the GRM/RDF 130 is aware that the terminals UT1, UT2 are participating in a terminal-to-terminal session.

In this process, the system avoids unnecessary complexity and power consumption at the satellites 102, because the calculation of the label stacks (e.g., routing paths through the constellation 110) is performed on the ground, at the GRM/RDF 130. The GRM/RDF 130 or another processing system can track and anticipate the movement of the satellites 102 to determine when the routing paths should change, such as when one or more satellites 102 used to pass data between the satellites SAT1, SAT2 move out of range and need to be replace with links to other satellites 102.

Once the satellites SAT1, SAT2 that provide connectivity to the cells where the two terminals UT1, UT2 are located have the label stacks to reach each other through the satellite constellation 110, the terminal-to-terminal communication session can proceed to exchange user data over these paths. Various techniques can be used to route information in the session, with different levels of information being stored by the satellites or the user terminals to facilitate the connection. In some implementations, each of the two terminals UT1, UT2 receives information about the cell and/or satellite currently used to provide service to the other terminal UT1, UT2. For example, the terminal UT1 can store information that terminal UT2 is in cell “Cell2” which is served by satellite SAT2. Messages or transmissions sent by terminal UT1 can include the cell identifier and/or satellite identifier for reaching the destination terminal UT2. The satellite SAT1 already stores the label stack to reach satellite SAT2, so the portion of the link through the constellation 110 is already known. When messages from the terminal UT1 identify the destination being associated with satellite SAT2, the satellite SAT1 chooses and applies the routing stack that reaches satellite SAT2. When the messages reach SAT2, the satellite SAT2 can use the indication of the cell, e.g., “Cell2,” for the terminal UT2. As an alternative, the messages may not specify the cell, and the satellite SAT2 can itself maintain a table that tracks the current cell assignment for the terminal UT2 (e.g., according to an identifier for the terminal UT2, a network address for the terminal UT2, etc.).

As another example, after connection setup, the terminals UT1, UT2 may direct messages to each other simply by using IP addresses or other network addresses, and the satellites SAT1, SAT2 may store information that indicates the correspondence of various identifiers and parameters for terminals UT1, UT2 in the active terminal-to-terminal sessions. For example, along with receiving the satellite SAT1 routing labels for reaching the satellite SAT2 from the GRM/RDF 130, the satellite SAT1 can also receive the IP address of the terminal UT2 and/or other information (e.g., device identifier, temporary identifier, cell identifier for its current cell, satellite identifier for its current satellite, etc.). The satellite SAT1 may then look up the appropriate destination satellite from this information when provided an IP address or other identifier for the destination terminal UT2, without having to send and receive the information again from the GRM/RDF 130 on the ground. Other identification techniques to translate between one form of identification to another can be used.

The system can perform several other steps to facilitate communication during the terminal-to-terminal session. For example, user plane handling at session initiation can include transferring security parameters from the application server 140 to the terminals UT1, UT2. The application server 140 can generate security parameters, such as one or more encryption keys, specifically for the current communication session. For user plane packet flows belonging to terminal-to-terminal sessions, the terminals UT1, UT2 use the encryption keys from the application server 140 for the session instead of encryption keys used for communicating between user terminals and the ground radio access networks 120a, 120b.

The first terminal UT1 sends packets using the IP address of the second terminal UT2 as the destination IP address, which the first terminal UT1 obtained via the user terminal discovery response (e.g., step 612). The UT2 sends packets using the IP address of the first terminal UT1 as the destination IP address, which the second terminal UT2 obtained in the presence query message (e.g., step 610).

In the communication session, the terminals UT1, UT2 both indicate that their packets are part of a packet flow for a terminal-to-terminal session (e.g., a session that bypasses ground radio access networks and ground stations) in their uplink Packet Data Convergence Protocol (PDCP) Extension packet headers.

In addition, or as an alternative, an ingress satellite 102 can establish a GPRS Tunnelling Protocol (GTP) tunnel with the egress satellite 102, similar to what a Centralized Unit (CU) on the ground would have established with a Distributed Unit (DU) on the egress satellite. This applies in both for data transfer in the direction from a calling terminal UT1 to a called terminal UT2, as well as in a direction from the called terminal UT2 to the calling terminal UT1. Here, the ingress satellite refers to the satellite 102 that receives a packet from a source terminal 105 to be routed through the constellation 110, and the egress satellite refers to the satellite 102 that outputs the packet to the destination terminal 105. For example, for sending a packet from the first terminal UT1 to the second terminal UT2, the satellite SAT1 is the ingress satellite 102 and the satellite SAT2 is the egress satellite 102.

As noted above, packet headers can include an indicator (e.g., a flag, a value, a code, etc.) that indicate that their packets are part of a packet flow for a terminal-to-terminal session. The headers can also include a cell identifier of the destination terminal 105, a Cell Radio Network Temporary Identifier (CRNTI) of the destination terminal, and a Logical Channel Identifier (LCID) (e.g., to indicate whether the data is a control signal, user data, a signaling message, etc.). The indicator, in addition to other information, can trigger ingress satellites 102 to use the label stacks provided for ingress to egress satellite to specify routing. For example, when the first terminal UT1 sends a packet for the second terminal UT2, the ingress satellite SAT1 determines that the packet has a packet header with an indicator value that the packet is part of a terminal-to-terminal session. In response, the satellite SAT1 selects the label stack that routes data only through the constellation 110 to reach the satellite SAT2.

The same indicator of terminal-to-terminal sessions, and information such as the cell identifier of the destination terminal 105 and the LCID, are used by egress satellites to (1) place Radio Link Control (RLC) blocks in the appropriate cell queue and (2) populate a MAC header with the LCID in downlink user link of the receiving terminal 105. For example, when the satellite SAT2 receives a packet through the constellation 110 that was sent by the first terminal UT1 and indicates the second terminal UT2 as the destination, the satellite SAT2 uses the cell identifier that is specified to know which cell the second terminal UT2 is in, and thus which cell queue the packet data for the terminal UT2 should be placed in. Similarly, the satellite SAT2 can populate the MAC header with the LCID to indicate the appropriate channel (e.g., specifying that the data is user data).

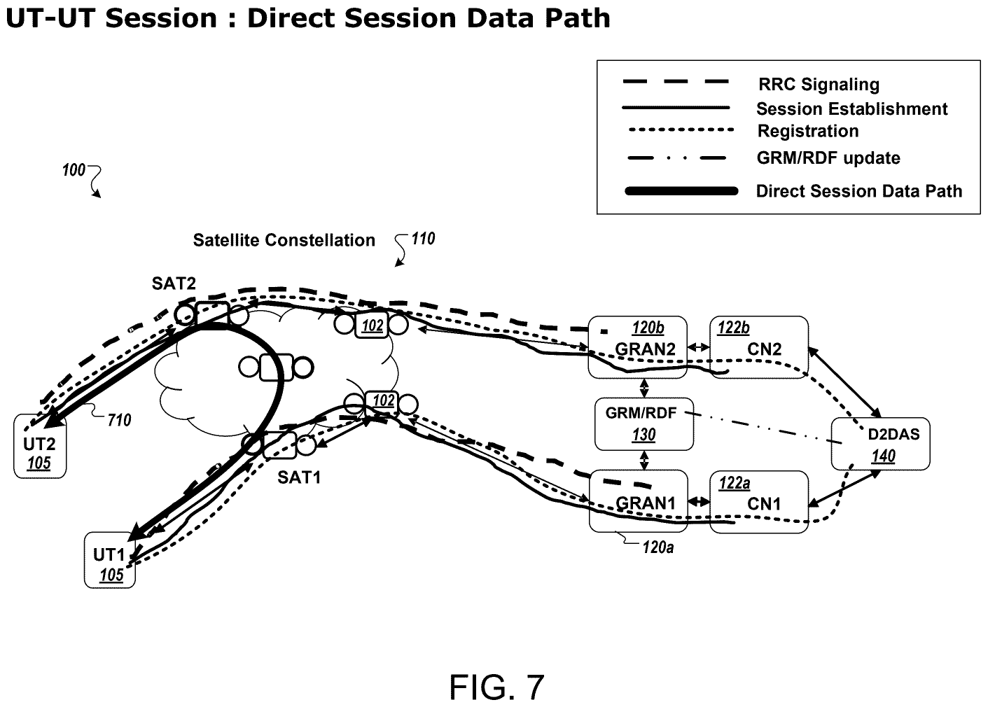

FIG. 7 is a diagram that shows an example of a terminal-to-terminal data path that has been established. For example, through the interactions shown in FIG. 6 and discussed above, the first terminal UT1 and the second terminal UT2 transfer user data (e.g., voice data of a phone call, video data of a video call, etc.) entirely through the satellite constellation 110 over the path 710. This path 710 includes the satellite SAT1, the satellite SAT2, and an intermediate satellite that relays packets between them.

Over time, the positions of the satellites 102 will change, and it will become necessary from time to time to perform satellite handover. For example, the terminal UT1 will switch from exchanging wireless signals with the satellite SAT1 to exchanging signals with another satellite. Satellite handover for the terminals UT1, UT2 can be triggered by their respective ground radio access networks 120a, 120b, in the same way as if the terminal was in a session of communication from terminal to ground radio access network.

As an example, consider a situation in which the terminal UT2 undergoes a satellite handover at a time t0. The terminal UT2 informs the terminal UT1 of the impending handover before time to. This notification can be a control plane application message over the direct terminal-to-terminal link over the path 710. In response to receiving notice of the upcoming change, the terminal UT1 sends an RRC message to its ground radio access network 120a to request updated labels to reach the new satellite 102 that the UT2 is handing over to. The Distributed Unit (DU) of the ingress satellite of terminal UT1 is then updated with new labels to reach the new satellite that the terminal UT2 is handing over to. In addition, the Distributed Unit (DU) of the new ingress satellite of terminal UT2 is updated with a set of labels to reach the satellite SAT1 that the terminal UT1 is currently communicating with.

When the terminal UT1 performs a satellite handover, the same process is performed again, except with the terminal UT1 notifying the terminal UT2, and the complementary adjustments being made to the routing labels.

In the case where the GRM/RDF 130 has an application function that is aware of the terminal-to-terminal session, the RRC message to request updated routing labels can be avoided. Route updates between an ingress satellite and a new egress satellite can be provided directly by the corresponding Centralized Units (CUs) in the ground radio access networks 120a, 120b, because the global resource manager is the element responsible for handover.

In some cases, the handover is simplified because both terminals UT1, UT2 are in the same cell or are in cells served by the same satellite 102.

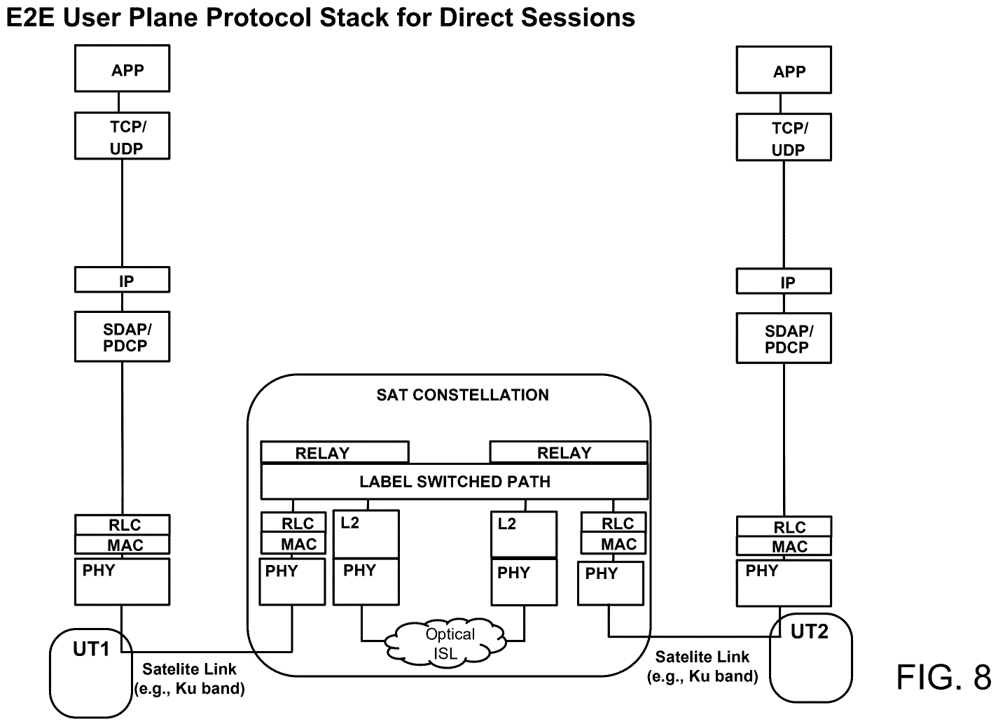

FIG. 8 is a diagram that shows an example of a protocol stack for supporting terminal-to-terminal data paths. For example, the figure shows a user plane protocol stack for Direct Sessions, which is similar to the protocol stack for user terminal to ground radio access network sessions. In some implementations, 3GPP control plane interactions for the two terminals UT1, UT2 are with their corresponding ground radio access networks 120a, 120b, similar to normal terminal to ground radio access network sessions. Therefore, an RRC layer is at the user terminal 105 and at the ground radio access networks 120a, 120b. Application layer messages exchanged with the application server 140 are provided over IP on the user plane, e.g., similar to the way a Direct Discovery Name Management Function (DDNMF) may exchange data. This architecture can be very effective to minimize complexity on each satellite 102.

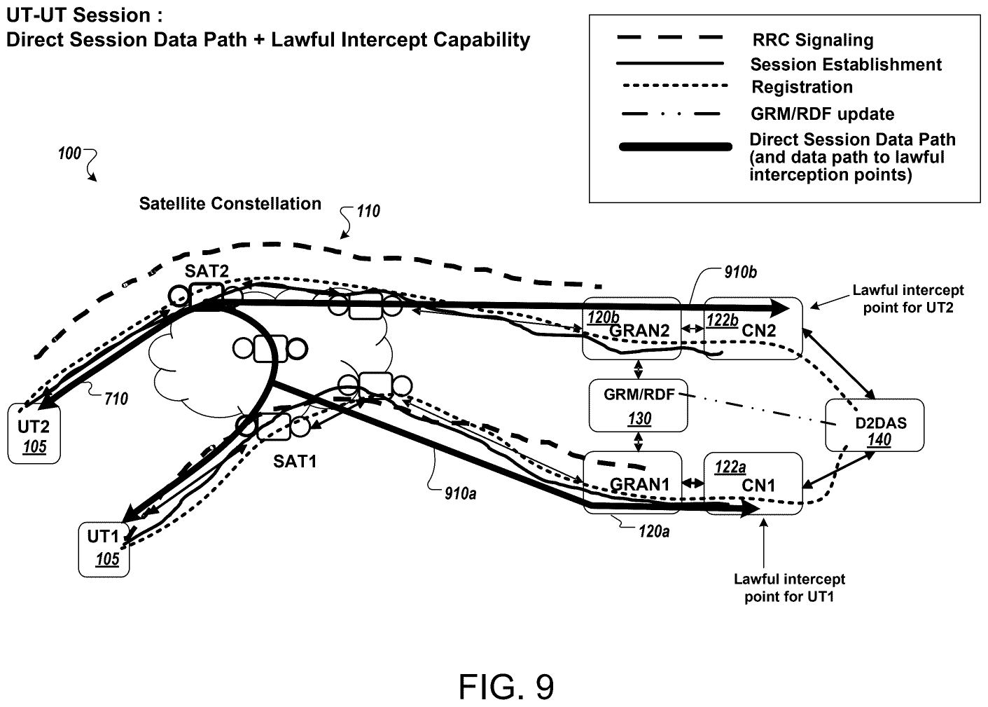

FIG. 9 is a diagram that shows an example of providing lawful intercept capability together with a terminal-to-terminal data path. When lawful interception is required, packets from the two user terminals UT1, UT2 have to be transmitted to the ground.

One option is that, because the packets are transmitted to the ground for lawful interception purposes, those terminal-to-terminal sessions may be looped on the ground (at the core network) like any other IP traffic. No special handling is needed for this type of core-network-looped terminal-to-terminal session, because the network traffic passes through the core networks 122a, 122b on the ground.

If direct UT-UT sessions are still desired, then a separate set of flags will indicate to ingress satellites that this is a UT-UT session that requires lawful interception. During the initial terminal-to-terminal session setup, and in particular during the initial route determination, the GRM may determine that the terminal-to-terminal session needs lawful interception (e.g., based on stored policies, locations of the terminals, etc.). In that case, the GRM may provide two stacks of labels to ingress satellites so that it can replicate the same PDCP to other UT as well as ground. In other words, each packet that is sent through the terminal-to-terminal path 710 directly through the constellation 110 is also separately sent to a ground radio access network 120a, 120b and core network 122a, 122b, e.g., through path segments 910a, 910b. The core networks 122a, 122b each provide a lawful intercept point for packets sent by the corresponding terminal UT1, UT2.

To facilitate lawful interception, PDCP layers at the individual ground radio access networks 120a, 120b are configured for no header compression or no encryption/decryption for terminal-to-terminal flows. Transmissions from the first terminal UT1 are decrypted at the second terminal UT2, but are not decrypted at the ground radio access networks 120a, 120b. However, the intercepted IP packets at UPF1 may be decrypted using keys provided by application server 140, because the keys used by the terminal UT1 and the terminal UT2 for the terminal-to-terminal communication were provided by the application server 140. This way, lawful intercept is completely transparent to the individual end users.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method performed by one or more computers, the method comprising:
enabling, by the one or more computers, a communication session that routes user data between a first terminal and a second terminal over a satellite communication network without routing the user data through any intermediate ground stations, comprising:
receiving, by the one or more computers, a discovery message from a first terminal for initiating communication with a second terminal, wherein the first terminal is located in a first cell and communicates with a first satellite, and wherein the discovery message includes an identifier for the second terminal;
in response to receiving the discovery message, sending, by the one or more computers, a query directed to the second terminal using a network address for the second terminal;
receiving, by the one or more computers, a response to the query from the second terminal, wherein the response includes a cell identifier for a second cell where the second terminal is located, a satellite identifier for a second satellite with which the second terminal communicates, and a temporary identifier of the second terminal; and
after receiving the response to the query, sending, by the one or more computers, a discovery response to the first terminal, wherein the discovery response includes the cell identifier for the second cell and the temporary identifier for the second terminal.

2. The method of claim 1, further comprising notifying a resource manager associated with one or more ground-based radio access networks that the first terminal and the second terminal are establishing a terminal-to-terminal communication session, such that the resource manager responds to routing requests for the first terminal and the second terminal to provide label stacks for a satellite-to-satellite path of communication between the first satellite and second satellite.

3. The method of claim 1, wherein the network address of the second terminal is an Internet protocol (IP) address, and wherein the query provides an Internet protocol (IP) address for the first terminal to the second terminal.

4. The method of claim 1, wherein the discovery message comprises a proximity services identifier for the second terminal; and
wherein the method comprises determining a network address for the second terminal based on the proximity services identifier for the second terminal.

5. The method of claim 1, comprising providing, to the first terminal and the second terminal, security parameters for the communication session.

6. The method of claim 1, wherein providing the security parameters comprises providing one or more encryption keys for encryption of user data passed between the first terminal and the second terminal in the communication session, wherein the one or more encryption keys are different from encryption keys used by the first terminal and second terminal for communication with ground radio access networks.

7. The method of claim 1, wherein sending the query comprises sending a presence query message.

8. The method of claim 1, comprising, before enabling the communication session:
registering the first terminal;
providing, to a route determining function (RDF), an update comprising information about the first terminal;
registering the second terminal; and
providing, to a route determining function (RDF), an update comprising information about the second terminal.

9. The method of claim 1, wherein the first cell is different from the second cell, and the first satellite is different from the second satellite.

10. The method of claim 1, wherein the identifier for the second terminal comprises a proximity services (ProSe) identifier for the second terminal.

11. A method comprising:
sending, by a first terminal, a discovery message to an application server configured to enable device-to-device communication sessions, wherein the first terminal is in a first cell and is connected to a network through a first satellite, wherein the discovery message includes an identifier for a second terminal;
receiving, by the first terminal, a discovery response from the application server, wherein the second terminal is in a second cell and is connected to the network through a second satellite, wherein the discovery response includes (i) a cell identifier for the second cell and (ii) a temporary identifier for the second terminal;
sending, by the first terminal, a request message to a ground radio access network to initiate a route label request, wherein the request message includes the cell identifier for the second cell and at least a portion of the temporary identifier for the second terminal;
after sending the request message, communicating, by the first terminal, with the second terminal in a communication session that routes user data through the first satellite and the second satellite without routing the user data through intermediate ground stations.

12. The method of claim 11, further comprising receiving, from the application server, security parameters for the communication session.

13. The method of claim 11, wherein the security parameters comprise one or more encryption keys for encryption of data passed between the first terminal and the second terminal in the communication session, wherein the one or more encryption keys are different from encryption keys used for communication with ground radio access networks; and
wherein the method comprises sending data to or receiving data from the second terminal in the communication session, wherein the data is encrypted using the one or more encryption keys.

14. The method of claim 11, wherein the temporary identifier comprises a Serving Temporary Mobile Subscriber Identity (S-TMSI).

15. The method of claim 11, wherein the request message comprises a radio resource control (RRC) message to cause a route determining function associated with a core network to determine route labels.

16. The method of claim 11, comprising:
obtaining a network address for the second terminal from the discovery response; and
communicating with the second terminal by sending packets that indicate the network address of the second terminal from the discovery response as a destination network address for the packets.

17. The method of claim 11, comprising communicating with the second terminal by sending packets that have headers that comprise one or more values indicating that the packets are part of a terminal-to-terminal session.

18. The method of claim 17, wherein the headers comprise Packet Data Convergence Protocol (PDCP) Extension headers.

19. The method of claim 11, comprising communicating with the second terminal by exchanging packets over a network tunnel established between the first satellite and the second satellite.

20. The method of claim 19, wherein the network tunnel is a general packet radio service (GPRS) Tunneling Protocol (GTP) tunnel.
